(19) United States
(12) Patent Application Publication
(10) Pub. No.: US 2006/0192960 A1
(43) Pub. Date: Aug. 31, 2006

(54) Polarization detection

(76) Inventors: Erik V. Rencs, Ellicott City, MD (US); Jerome E. Oleksy, Park Ridge, IL (US)

Correspondence Address: FISH & RICHARDSON PC, P.O. BOX 1022, MINNEAPOLIS, MN, 55440-1022, US

(21) Appl. No.: 10/550,164

(22) PCT Filed: Mar. 24, 2004
(86) PCT No.: PCT/US04/08906

§ 371 Date: Sep. 20, 2005

Related U.S. Application Data
(60) Provisional application No. 60/456,928, filed on Mar. 24, 2003.

(51) Int. Cl. G01J 4/00

(52) U.S. Cl. 356/364

(57) ABSTRACT

Disclosed is an optical device for receiving light having a wavelength between 400 nm and 680 nm. The device has a polarizing beam splitter (PBS) that comprises a substrate having a first and second surface, at least one of which being coated with a substantially parallel array of elongated conducting elements, wherein the PBS reflects light of a first polarity and transmits light of the opposite polarity; and a reflector positioned to reflect the opposite polarity light back through the PBS to the front surface, wherein the reflector does not substantially alter the polarity of light at any position. The device can be used to detect fluorescence polarization of a sample.

### CROSS-REFERENCE TO RELATED APPLICATIONS

This application claims priority to U.S. Application Ser. No. 60/456,928, filed on Mar. 24, 2003, the contents of which are hereby incorporated by reference.

### BACKGROUND

The invention relates to detection of polarized light.

Polarized light has numerous applications in both natural and physical sciences. For example, detection of polarized light in a variety of wavelengths (including UV, visible, and infrared) can be used to obtain information about a sample. Similarly, polarized light can be used to send signals, e.g., liquid crystal displays manipulate the polarization state of light to alter the appearance of the display for a user.

One exemplary application of polarized light is the detection of light emitted by a fluorescent compound. Properties of the fluorescent compound can be determined based on information about the detected light. In particular, fluorescence polarization (FP) provides information about the molecular size of the fluorescent compound.

Fluorescence polarization provides a measure of rotational motion of the fluorescent compound during a time delay in the process of fluorescent light emission. The fluorescent compound (which can be, e.g., a macromolecule to which a fluorophore is covalently or non-covalently attached) is excited with plane-polarized light. After a delay, the fluorescent compound emits light using the excitation energy from the absorbed polarized light. The emitted light is polarized in the same as the plane as the excitation light, provided the compound is immobile. In solution, however, the molecule tumbles during the delay at a rate that is a function of its molecular size. Larger molecules rotate more slowly, and accordingly emit more light in the same polarization plane as the excitation light. Conversely, small molecules rotate more quickly, and disperse the polarization of the excitation light. Analysis of the polarization of the emitted light provides information about the size of the molecule.

Some systems that are used to analyze fluorescence polarization use polarization separators specialized for a particular wavelength band. These systems also typically use two separate detectors, one for each polarity. Because of their narrow band-width, the polarization separators are replaced, moved or changed when light in another wavelength band is measured.

### SUMMARY OF THE INVENTION

In one aspect, the invention features an optical device for receiving light, the device including: a polarizing beam splitter (PBS) that substantially reflects light of a first polarization and substantially transmits light of a second polarization orthogonal to the first polarization; a reflector positioned to reflect light transmitted by the PBS towards the PBS; and a detector positioned to detect light reflected by the PBS and/or light reflected by the reflector. For example, the reflector is angled relative to the PBS.

In a related aspect, the invention features an optical device for receiving light, the device including: a polarizing beam splitter (PBS) which substantially reflects light of a first polarization and substantially transmits light of a second polarization orthogonal to the first polarization; a reflector positioned to reflect light transmitted by the PBS towards the PBS, wherein the reflector is angled relative to the PBS such that a light beam that has a non-zero angle of incidence at the PBS is separated into a first beam having substantially the first polarization and a second beam having substantially the second polarization; and a detector positioned to detect in the first or second beam.

In one embodiment, the device is configured so that upon reflection of the second beam by the reflector, the angle between the first and second beam is at least 10, e.g., between 25 and 1, 10 and 1, or 5 and 1°. In one embodiment, the device is configured to receive light having a wavelength between 380 nm and 780 nm, e.g., between 400 nm and 680 nm. In one embodiment, the PBS includes substrate having a first and second surface, at least one of which being coated with a substantially parallel array of elongated conducting elements, and the coated surface substantially reflects light of the first polarization and substantially transmits light of the second polarization. For example, the detector includes a first and second region. The detector is positioned to receive the first beam in the first region and the second beam in the second region.

In one embodiment, the reflector includes a coating on the second surface of the PBS substrate, and the PBS second surface and the PBS first surface are angled.

In one embodiment, the optical device further includes a polarizer positioned in the path of the first beam, but not the second beam, wherein the polarizer is oriented substantially transmit light of the first polarization. In one embodiment, the optical device further includes an optical element that directs light from the sample to the PBS.

In another aspect, the invention features a method that includes: exciting the sample with excitation light; directing emitted light from the sample at an optical device described herein; and detecting light at the detector. The method can be used to detect fluorescence polarization of a sample. For example, the PBS of the device includes substrate having a first and second surface, at least one of which being coated with a substantially parallel array of elongated conducting elements, and the coated surface substantially reflects light of the first polarization and substantially transmits light of the second polarization. In one embodiment of the method, the excitation light is polarized in a single plane. In another embodiment, the excitation light is circularly polarized.

The detecting can include detecting light in the first and second beam. For example, light in the first and second beam is detected concurrently.

In one embodiment, the sample includes a plurality of regions. For example, the detecting includes concurrently detecting light in the first and second beam for each region of the plurality of regions.

The method can further include determining an FP value for each region of the plurality, the FP value being a function of the first polarity light and the opposite polarity light.

In one embodiment, the sample includes a fluorescent compound.

In one embodiment, the method further includes determining a parameter descriptive of the fluorescence polarization of the fluorescent compound. The method can include other features described herein.

In another aspect, the invention features a method that includes: exciting the sample with first polarized excitation light; directing first emitted light from the sample at an optical device described herein; detecting light in the first and second beam to evaluate orthogonal components of the first emitted light; exciting the sample with second polarized excitation light, non-parallel to the first polarized excitation light; directing second emitted light from the sample at the optical device; detecting light in the first and second beam to evaluate orthogonal components of the second emitted light; and determining a first value that is a function of the components of the first emitted light and a second value that is a function of the components of the second emitted light. The method can be used to evaluate a sample.

The method can further include evaluating a function that depends on the first and second values (e.g., comparing or averaging the first and second values).

In one embodiment, the first and second polarized excitation light have the same peak wavelength. For example, the first and second polarized excitation light have peak wavelengths that differ by at least 10, 20, 50, or 80 nm.

In one embodiment, the sample includes a plurality of fluorophores, each having a different spectral profile. The method can include other features described herein.

In another aspect, the invention features a polarizing beam splitter (PBS) that includes: an optically transparent substrate, having a front surface and a rear surface angled relative to the front surface; a generally parallel array of elongated elements disposed on the front surface of the substrate configured to substantially reflect light of a first polarization, and substantially transmit light of a second polarization orthogonal to the first polarization; and a reflective coating disposed on the rear surface. For example, the elements are composed of aluminum or silver. The array can be configured to polarize light having a wavelength between 380 nm and 780 nm, e.g., between 420 and 600 nm. For example, the angle between the front and rear surfaces is between 2 and 65, 5 and 50°, or 5 and 30°. In one embodiment, the reflective coating does not substantially alter the polarization of light that it reflects. For example, the reflective coating is substantially uniform.

In one embodiment, the substrate is a wedge. For example, the rear surface is angled relative to the front surface. The angle can be such that a light beam that has a non-zero angle of incidence at the front surface is separated into a first beam having substantially the first polarization and a second beam having substantially the second polarization, and upon reflection of the second beam by the reflector, the angle between the first and second beam is at least 1°, e.g., between 1 and 5° or 1 and 20°.

In another aspect, the invention features a method that includes: collecting light from a plurality of distinguishable positions on an illuminated object; separating the collected light according to polarity using an optical element that reflects light polarized in a first plane and transmits light in a second plane, orthogonal to the first plane; projecting the reflected light and the transmitted light onto a detector surface; and comparing the reflected and the transmitted light for each of the distinguishable positions to thereby determine fluorescence polarization at each of the distinguishable positions. The method can be used to evaluate fluorescence polarization. The method can include other features described herein. For example, the light in the second plane is reflected off a reflector towards the optical element.

In another aspect, the invention features a method that includes: providing a plurality of spatially distinct nucleic acid samples and amplification reagents that includes a fluorophore attached to a nucleic acid primer; concurrently amplifying each sample of the plurality; and during the amplifying, concurrently detecting fluorescence polarization information associated with the fluorophore from each sample of the plurality, wherein the detecting includes separating first and second polarity light using an element that reflects first polarity light and transmits second polarity light, wherein the first polarity light is polarized in a first plane and the second polarity light is polarized in a plane orthogonal to the first plane. For example, the first and second polarity light are detected concurrently. For example, the first and second polarity light are detected by the same detector.

In one embodiment, the element includes an optically transparent substrate having a first and second surface and a parallel array of conductive material coated on the first surface. The method can include other features described herein.

In another aspect, the invention features an apparatus that includes: an optical device described herein; a light source; and a retainer configured to position a sample to receive light from the light source and to direct light emitted from the sample to the optical device. The apparatus can further include: a thermal controller for regulating the temperature of the sample, and optionally the sample.

In one embodiment, the retainer is configured to position a plurality of discrete samples to receive light from the light source and to direct light emitted from the sample to the optical device. For example, the retainer is configured to position a multi-well container, a microscope slide, or an array. In one embodiment, the sample includes a plurality of spatially separated nucleic acid samples. In one embodiment, the thermal controller is configured to cyclically regulate temperature to effect a cycles that includes two or more of: nucleic acid annealing, extension, and denaturation.

An optical device described herein can be used, e.g., to detect two orthogonally polarized light beams (e.g., ‘s’ and ‘p’ polarized beams) imaged onto the detector without the need for narrow spectral bandwidth, laser illumination, or narrow field-of-view.

Other features and advantages of the invention will be apparent from the following detailed description, and from the claims. All patents, patent applications (inclusive of 60/456,928, filed Mar. 24, 2003 and Ser. No. 10/155,285), and references cited herein are incorporated in their entirety by reference.

### BRIEF DESCRIPTION OF THE DRAWINGS

FIGS. 1, 2, and 4 depict exemplary systems for detecting s and p polarized light.

FIG. 3 depicts an exemplary wired polarizing beam splitter.

FIGS. 5 and 6 depict exemplary apparati for detecting fluorescence polarization of reaction mixtures.

### DETAILED DESCRIPTION

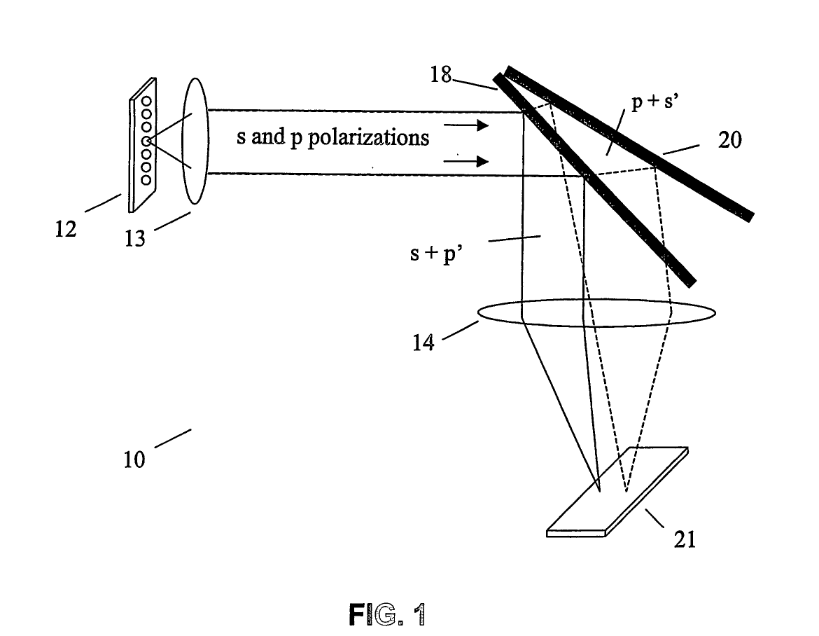

Referring to the exemplary system 10 in FIG. 1, the object 12 to be imaged is shown at the left. Light emitted from the object is collected and collimated by an optical system 13. The collected light is directed toward a reflective polarizer 18. The angle of incidence of the light at the reflective polarizer can be greater than 30°, e.g., about 45°. The polarizer 18 reflects substantially all light having s-polarization (i.e., light polarized perpendicular to the plane of FIG. 1) and transmits substantially all p-polarized light (i.e., light polarized parallel to the plane of FIG. 1). As used herein, substantially all light having a certain polarization state means at least 70% (e.g., at least 80%, 90%, 95%, 97%, 98%, 99%, 99.5%) of the light of that polarization state at the wavelength or wavelength range of interest.

In many implementations, in addition to reflecting s-polarized light, reflective polarizer 18 also reflects a portion (e.g., less than about 10% of the p-polarized light at the wavelength or wavelength range of interest) of the p-polarized light, referred to as p′. Similarly, light transmitted by reflective polarizer 18 can include some contaminating s-polarization light, s′.

One exemplary type of reflective polarizer that can be used is a “wired” reflective polarizer. This type of reflective polarizer includes a parallel array of elongated elements, so-called “wires”, and preferentially reflects light polarized parallel to the elongated elements. The polarization contrast of reflected light (i.e., the ratio of the polarizer reflectance of light polarized parallel to the elements to the reflectance of orthogonally polarized light) can be high, e.g., more than about 8:1, such as 10:1 or more. Conversely, a wired reflective polarizer preferentially transmits light polarized orthogonal to the elongated elements. The polarization contrast of transmitted light (i.e., the ratio of the polarizer transmittance of light polarized orthogonal to the elements to the transmittance of light polarized parallel to the elements) can be high, e.g., more than about 8:1, such as 10:1, 20:1, 50:1 or more. Reflective polarizers are also known as polarizing beams splitters (PBS's) and the terms are used interchangeably below. See, “Wired Polarizing Beam Splitter” below for additional description of the wired PBS.

The light reflected by polarizer 18, (indicated by s+p′ in FIG. 1) is directed by a second optical system 14 (e.g., one or more lenses) to a first region of a detector 21.

The light that is transmitted through the polarizer 18 first surface of “wires” is directed towards the mirror 20 which reflects the transmitted light towards detector 21. As shown, the angle of incidence of the transmitted light is non-zero relative to the plane of the mirror 20 so that the transmitted light is reflected along a different path through reflective polarizer 18, preferably along a path that is angled relative to the light beam reflected by the polarizer front surface. The transmitted light (indicated as p+s' in FIG. 1), which is redirected thorough the polarizer 18, is re-filtered in substantially the same way as if it was incident on the front of the polarizer such that s' light component is again reflected by the polarizer 18 front surface rather than transmitted. This retransmission further polarizes the beam of p-polarized light impinging on the detector 21.

Mirror 20 is coated with material that reflects substantially all of light transmitted by polarizer 18 without substantially changing the polarization of the transmitted light. A substantial change in the polarization of that light by the mirror 20, would reduce the amount of light that is transmitted back through the beamsplitter 18.

The angle between the beamsplitter and the mirror causes the light reflected by mirror 20 to be non-parallel to light reflected from the front surface of polarizer 18. The difference between the propagation directions of light reflected from polarizer 18 and mirror 20 causes optical system 14 to focus the light from the different surfaces to different portions of detector 21. In other words, system 10 images light of a first polarization state emitted from sample 12 to a first region on detector 21, and images light of the orthogonal polarization state to another region on the detector.

The divergence of light reflected from the polarizer and light reflected from mirror 20 depends on the wedge angle between the reflective surfaces of the polarizer and the mirror. If the wedge angle is zero, the propagation direction of the light from the surfaces will be parallel. For a non-zero wedge angle, the angle of divergence between the propagation directions will increase with increasing wedge angle. In preferred embodiments, the wedge angle should be sufficiently large so the spatially separate light reflected from the polarizer and light reflected from the mirror at detector 21, although, in general, the wedge angle may be varied as desired. For example, the wedge angle can be greater than 1°, such as 2°, 5°, or more. Similarly, the angle of divergence between the beams can be greater than 1°, such as 2°, 5°, or more.

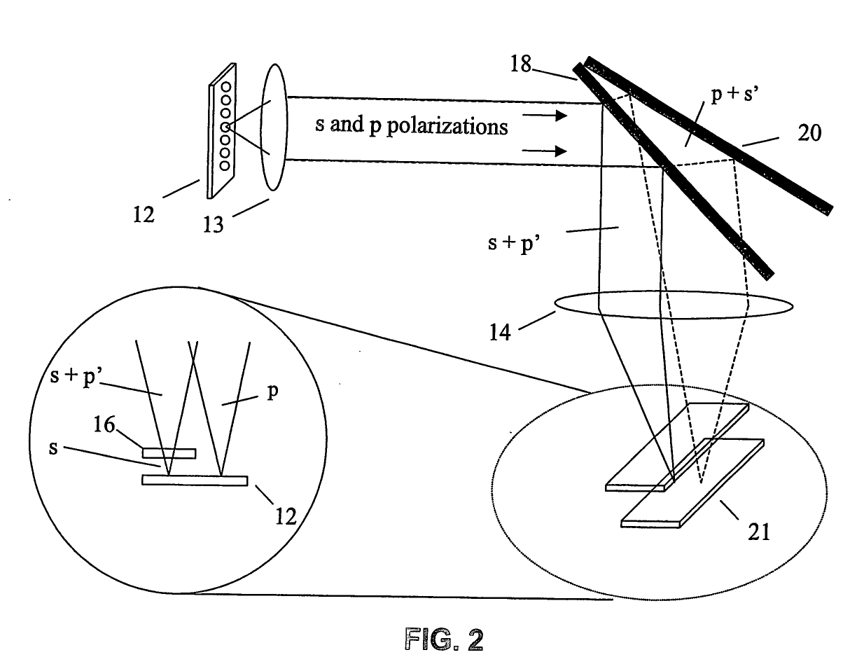

In the embodiment shown in FIG. 2, light reflected from reflective polarizer 18 (s+p′) can be directed towards a polarizer 16 that is oriented to further polarize the light (e.g., to remove the p′ component) by, e.g., by absorbing or reflecting the unwanted polarization state. The wedge angle and location of the polarizer 16 are such that light reflected from mirror 20 does not pass through the polarizer 16.

In general, detector 21 can be any detector capable of detecting light at the wavelength or wavelengths of interest. Preferably, detector 21 is a detector array (i.e., includes) an array of detector elements (i.e., pixels), capable of distinguishing between the intensity of light at different regions of the detector. The detector can be a charged-coupled device (CCD) camera, a single photo-multiplier tube (PMT), an array of PMTs, or include one or more photodiodes.

The system 10 can also include additional components (not shown), e.g., narrow-band filters, shutters, various lenses and other optical elements to facilitate the illumination or imaging paths of the system

The exemplary system 10 described above can be used for a variety of applications. The system can be used to evaluate the fluorescence polarization of one or more samples. In a particular example, described below, the system is used to evaluate the fluorescence polarization of a plurality of samples during a nucleic acid amplification process.

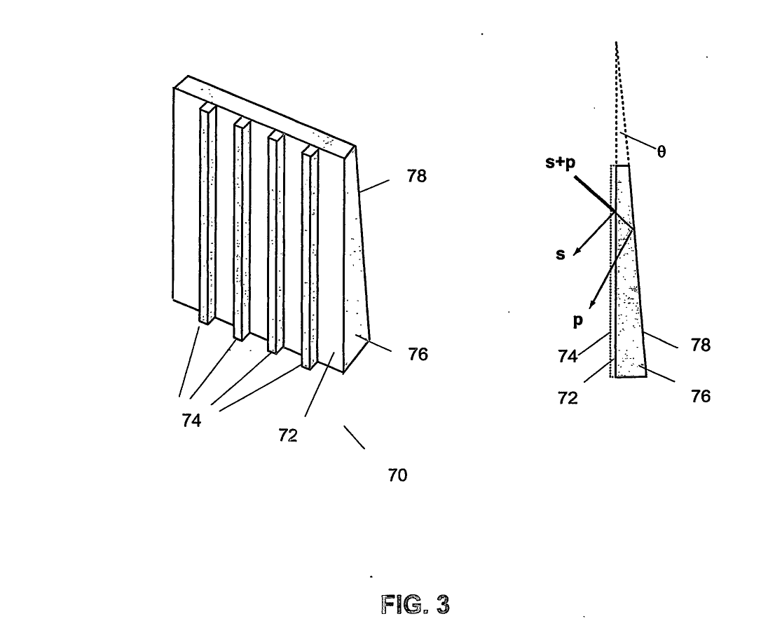

Referring to the example in FIG. 3, a reflective polarizer 70 includes a substrate 76 having a front surface 72 and a rear surface 78. The front surface 72 is coated with an array of parallel wires. The rear surface 78 is reflective and non-parallel to the front surface 72. As shown in the side cross section, the front and rear surfaces form an angle θ. For example, the substrate 76 is a glass wedge. As a result, a light beam including light of polarizations s and p is separated into two non-parallel beams. The s polarization light is reflected by the front surface by the angle of incidence α. The p polarization light is transmitted through the front surface and then reflected by the rear surface 78. The p polarization light reemerges from the front surface at an angle α-θ because the rear and front surfaces are non-parallel.

The reflective polarizer/PBS can be generally prepared as described in U.S. Pat. No. 6,243,199 with appropriate modification. Typically, the substrate is a wedge so that the rear surface is angled relative to the front surface. The rear surface is coated with a reflective material. Exemplary coating materials include silver, aluminum, or a multilayer of dielectric materials

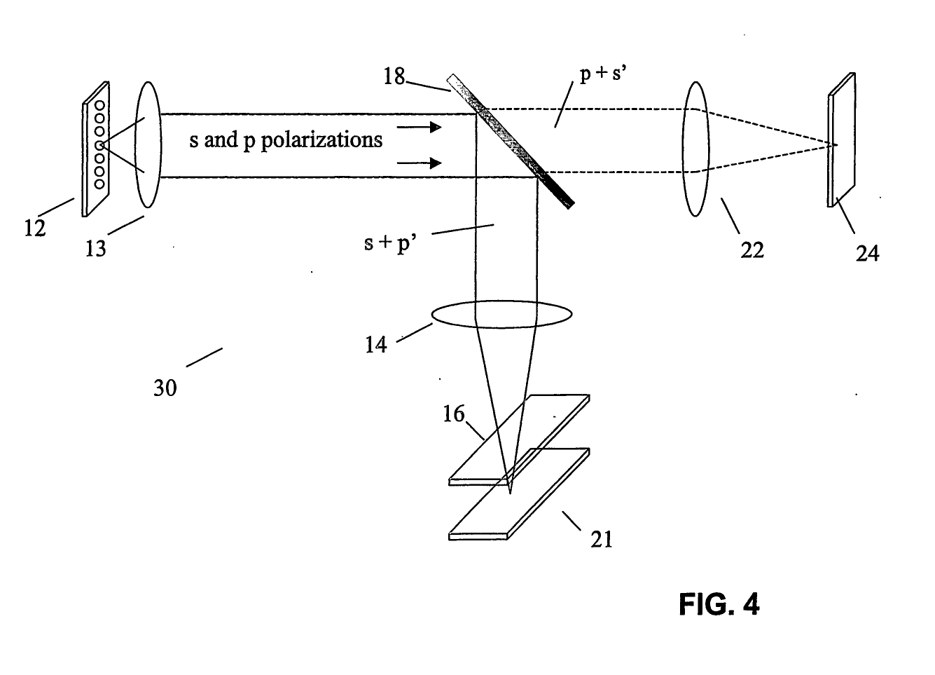

Referring to the exemplary system 30 depicted in FIG. 4, light from an object 12 is collimated and directed to the wired PBS 18. Light reflected by the wired PBS (i.e., s+p′) is imaged to and detected by detector 21. The polarization contrast of light reflected by PBS 18 can be increased by polarizer 16. Unlike system 10, in this system, light transmitted by PBS 18 (p+s′) is detected by a second detector 24. The system can include additional elements, e.g., one or more polarizers (that absorb or reflect out of plane light) appropriately positioned to further refine the transmitted and/or reflected light beams. Lenses 14 and 22 can be used to focus the light onto the detectors.

Wired PBS

The wired PBS or “wired grid” PBS is one type of PBS that can be used to separate light into two orthogonal components of linear polarization. In these devices, the light polarized perpendicular to the wires in the grid is preferentially reflected off the front of the device, while light polarized parallel to the wires is preferentially transmitted through the device.

Methods for providing a wired PBS are described, e.g., in U.S. Pat. Nos. 6,234,634 and 6,243,199. The wired PBS includes a transparent substrate, typically glass (e.g. BK7 glass), that is coated with a parallel array of elongated elements, so-called “wires.” The wires can be spaced with a periodicity, thickness, and width as described in U.S. Pat. Nos. 6,234,634 and 6,243,199. For example, for polarizing light in the visible region of the electromagnetic spectrum, the elements can have a periodicity of less than 0.21 μm, a thickness of between 0.04 and 0.5 μm, and a width that is equal to 30 to 70% of the period.

The wires can be made of a conductive and reflective material, e.g., aluminum or silver. Exemplary PBS elements of this type are available from Moxtek (Orem, Utah) and Meadowlark (Frederick, Colo.), e.g., as Microwire™ Beamsplitters and VersaLight OFC 2001.

A wired PBS can provide transmitted and reflected polarized light with high degree of efficiency (e.g., a polarization contrast in both the reflected and transmitted beams of more than 8:1, 10:1, 20:1, and/or with low absorption, e.g., less than 20%, 10%, 5% absorption at the wavelength or wavelengths of interest). These devices can efficiently polarize light over a broad range of wavelengths, a high field-of-view, and can be durable, e.g., can operate consistently over a wide range of temperatures, and/or can be resistant to physical and/or chemical abrasives. The wired PBS is also not limited in size, for example, the length of the wired PBS can be greater than 2.5 cm (one inch). Preferably the wired PBS has a flat transmission response of a wide angle of incidence, e.g., from 30° to 60° across the visible spectrum (e.g., from 380 nm to 780 nm, 450 nm to 650 nm).

Although the above-described embodiment utilizes a wired PBS, other reflective polarizers can be used. For example, reflective polarizer 18 (FIG. 1) can be a multilayer reflective polarizer. Examples of multilayer reflective polarizers are described in U.S. Pat. No. 5,882,774. Generally, these polarizers include an optical stack in which dielectric layers are index matched along one direction, but which have a refractive index mismatch along the orthogonal direction. The stack preferentially reflects light plane polarized parallel to the direction with the refractive index mismatch, and preferentially transmits light plane-polarized parallel to the direction along which the refractive index of adjacent layers are matched.

Macromolecule Detection

In some embodiments, the apparatus described herein is used to detect polarized light from a sample that includes a macromolecule, e.g., a biological macromolecule such as a protein, nucleic acid, or oligosaccharide. In one example, the apparatus includes a sample carrier such as a multiwell plate, an array or a glass slide. The entire carrier or a region of the carrier that includes a plurality of different samples can be imaged concurrently. The apparatus can evaluate fluorescence polarization (FP), e.g., by concurrently detecting light of orthogonal polarization states emitted from the samples.

In a particular example, the apparatus is used to monitor nucleic acid amplification. The FP value can be correlated with the amount of nucleic acid product present at various instances during the amplification. One exemplary nucleic acid amplification method is the polymerase chain reaction (PCR), other examples are described below.

Thermal Cycler Assembly

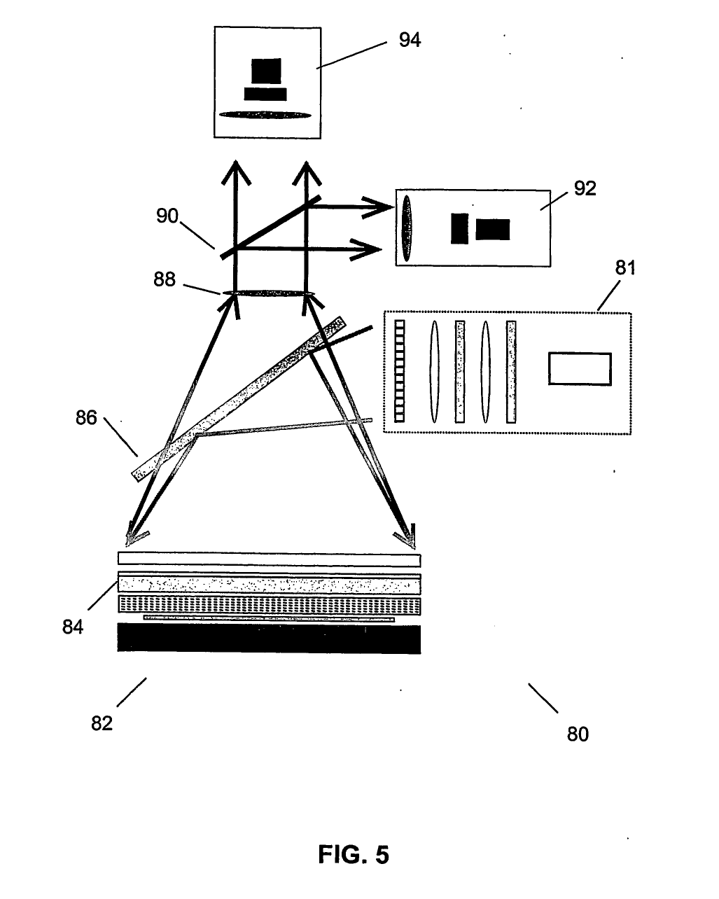

Referring to FIG. 5, an exemplary apparatus 80 for FP-PCR analysis includes a thermal cycler assembly 82 and an optical assembly that features a PBS 90 as well as a light source 81 and detectors 92 and 94. The apparatus is configured so that a sample carrier 84 is positioned on the thermal cycler assembly 82. Optics direct linearly polarized light from the light source 81 to the sample carrier 84 in order to excite fluorescent molecules in the sample carrier 84. Light emitted by these molecules is collimated by an optical element 88 in the detection path.

The thermal cycler assembly 82 includes a heat transfer block upon which the sample carrier 84 is disposed. The temperature of the heat transfer block is controlled by a heat-cold source and a heat sink for cooling. Other designs can be provided by one of ordinary skill in the art. The assembly can include a Peltier-effect device for temperature control. Peltier-effect devices use a solid-state technology for thermoelectric heating and cooling. The devices can operate without moving parts, and usually has a fan to remove excess heat. In some embodiments, the heat transfer block is configured to provide a spatial temperature gradient.

The sample carrier 84 can include a plurality of areas on or in which reactions can occur, e.g., for replicates or different samples. Exemplary sample carriers include a microtitre plate, one or more (e.g., an array) of capillaries, a microfluidic system (e.g., cartridge) and so forth. For example, the sample carrier can include multiple containers such as the multiple wells of a standard microtitre plate with 96 or 384 wells. In another example, the sample carrier includes a histological sample for in situ amplification, e.g., the sample carrier includes a planar glass surface. In still another example, the carrier includes a set of arrayed samples on a contiguous surface.

The sample carrier is typically covered by a transparent seal. For example, the seal can be composed of materials such as plastics that are transparent to visible and UV light, e.g., a material that is uniformly birefringent, e.g., a material such as polyester or polyolefin. The seal is, in turn, covered by a transparent heated lid. The heated lid can serve at least two functions. One function is to apply pressure to the seal so that it retains closure of the wells. A second function is to maintain the temperature on the top of the sample carrier during PCR amplification, e.g., to prevent condensation of liquid that may evaporate from the sample. The heated lid can be composed of common optical materials such as BK7 or Fused-Silica and may encompass a thin-film, optically transparent heat source or be attached to another type of heat source that provides the required temperature (e.g., ˜104° C.) and uniformity of temperature (e.g., ˜4° C.).

Light Source Assembly

Referring also to FIG. 5, the light source assembly 81 provides a beam of polarized excitation light. Light from the source passes through, e.g., a heat-absorbing filter, a lens, a band-pass filter, a second lens, and a polarizer. Specific configuration of the assembly can depend on the implementation and the desired performance.

Light Source. The light source has several important components. The source itself can be one of several configurations. The source can be a quartz-tungsten halogen, a Xenon (continuous or flash) light source, a mercury light source, a laser and others. The source can be a bulb that emits in all directions and requires collimating optics to make it efficient. Other sources can have optical components built into the design that collect and direct the light. If the source is a non-polarized source, then the light is subsequently polarized (e.g., see polarizers, below) to provide and limit the light that reaches the sample to one direction of linear polarization. Depending on the implementation and desired performance, it may be advantageous to use a non-polarized source or to use a polarized source.

In the case of broadband sources, other optical components, such as lenses, direct light through a band-pass filter to select the wavelength range of interest for the excitation light. These filters can be thin-film interference filters with on the order of 20 nm full-width-half-max (FWHM) bandpass and on the order of 60 to 90% peak transmission.

In some implementations, the illumination system provides uniform light to a large area. One method for achieving this uniformity is to diffuse the light source. In one embodiment, holographic type diffusers are used to achieve high uniformity and efficiency. Both holographic and conventional diffusers are commonly available from optical suppliers. Of consideration here is that these types of diffusers typically do not maintain polarization and thus need to be used prior to the polarizer.

Lenses within the light-source assembly guide and direct light through the filters, diffusers, mirrors and other optical components in order to reach the sample.

Polarizer. The polarizer used in the light-source assembly 81 can be fixed or variable. For example, the polarizer can be an absorptive sheet polarizer (e.g., a thin dichroic sheet material readily available in optics catalogs). More complex polarizers include active polarizing devices, such as devices that include liquid crystal cells to switch between orthogonal polarization states. Examples of such Liquid-Crystal Polarizers (LCPs) include devices that use an absorptive sheet polarizer to pre-polarize incoming light to a first plane-polarized state. The pre-polarized light is then transmitted through an liquid crystal cell which can either passively let the light pass, or actively rotate the plane of polarization of the light. Crystal polarizers, such as a Glan-Thompson polarizer, can also be used.

In some implementations, the light source module may include a fiber optic bundle to provide distinct sources of illumination for the individual sample wells. The fiber optic bundle can receive light from a single illumination source. In one example, these sources do not directly provide illumination to the well, but rather serve as a light source for an imaging system that projects light from the fibers to the wells, e.g., via a scanning mirror and other optics in the illumination path. In another example, each fiber directly illuminates a well, or a polarizing optical element designated for a discrete region of the sample carrier.

In another example, the fiber illumination system can illuminate either samples arranged using the separation spacing of a 96-well plate, or samples arranged using the separation spacing of a 384-well plate. Both fiber bundles are configured in an array. Then the fibers designated for the 96-well configuration are isolated into one bundle, and the 384-well configured fibers are isolated and directed into a second bundle. Since the fibers are flexible, the light source can remain stationary, and the appropriate bundle can be position to receive light from the light source. Equivalently, the fibers may remain stationary, and a mirror is moved to direct light to the appropriate fiber bundle. Typically, the fiber optic is not be utilized in the emission path, as that would perturb the spatial and polarization qualities of the image.

Detection Assembly

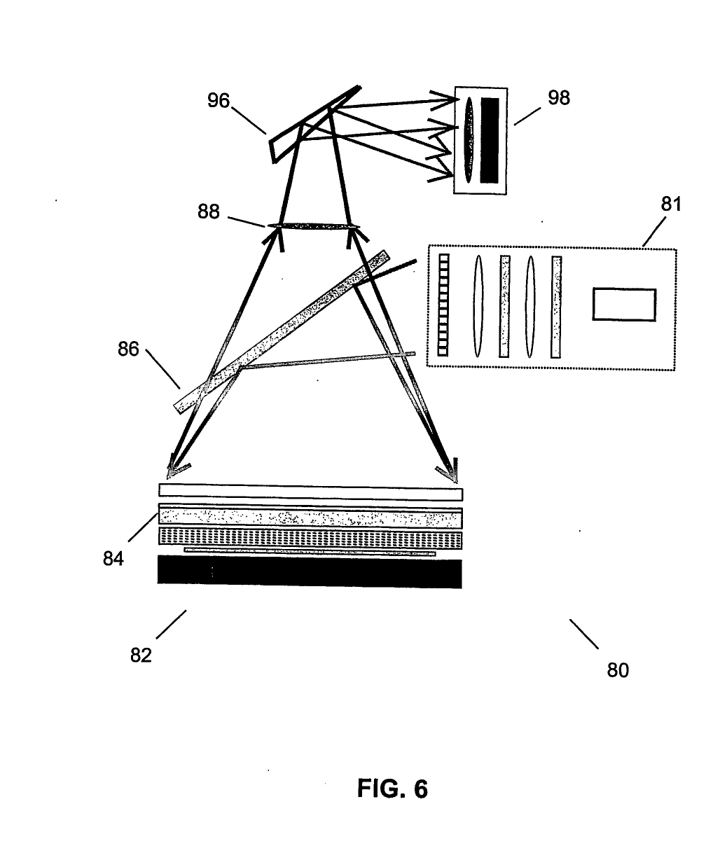

Referring again to FIG. 5, light emitted by molecules in the sample carrier 84 are collimated by the optical element 88. The light is directed at the wired PBS 90 so that light of one polarization is substantially reflected to a first detector 92 and light of the orthogonal polarization state is substantially transmitted to a second detector 94. In the exemplary configuration shown in FIG. 6, a wedge PBS is 96 is used so that light of one polarity is reflect off the front surface of the PBS at one angle and light of opposite polarity is reflected from the rear surface. This configuration enables light of both s and p polarization to be detected by a single detector 98. The detectors can be an array of CCDs or an array of PMTs.

The detection path can also include a band-pass filter, e.g., before the polarizer. The filters are emission filters that allow transmittance of light centered on the wavelength of the light emitted by the fluorophore. These filters are identical in function to that of the excitation filter, except that the center wavelength is shifted in wavelength according to the emission profile of the fluorophore. The lenses are optimized for collecting light from the sample and delivering it through the filters and the PBS to the detector.

Multiple pairs of excitation and emission filters (one of each make a pair) can be used for the various types of fluorophores that are used to monitor the PCR reaction. To assess multiple fluorophores in a single PCR reaction, the apparatus is outfitted with a plurality of these pairs.

The purpose of the PBS in this system is to enable light of both polarities to be concurrently detected, e.g., using a single detector or a plurality of detectors. One advantage of concurrent detection is speed. Since both readings are taken at the same time, additional time is not required to detect emitted light in the second direction. A second advantage is stability. The illumination for both directions of polarization is concurrent. Thus, measurements in the two directions result from the same amount of excitation light. Deviations in the illumination system that may result when the two measurements are made at two different points in time are avoided.

In one embodiment, the illumination system is configured to sequentially produce plane polarized light of a first state of polarization, and then light with the othogonal polarization. This can be done, e.g., by rotating a polarizer in the excitation light path. The detector is used to concurrently detect emitted light from the sample of both polarization states concurrently. Measurements made using the two different excitation light beams can be averaged, e.g., to reduce any error that might be inherent in one of the two detection paths.

In many configurations, the apparatus monitors FP for multiple samples concurrently. The area that includes the multiple samples is illuminated by the light source assembly and then detected using a pixelated detector, e.g., a system that includes an array that assigns values to different pixels of an image. This scenario has, among others, the advantage of speed. In a preferred embodiment, the sample carrier is fixed throughout the process. If the entire sample carrier cannot be concurrently imaged, it is possible to modify the optics to scan different regions of the sample carrier. For example, the detection system can include a scanning mirror to direct light from the different regions at the PBS. Additional details of apparati and methods which can be use a polarizing beam splitter for FP detection of a sample are described in U.S. patent application Ser. No. 10/155,285, filed May 23, 2002, titled “Fluorescence Polarization Detection of Nucleic Acids.”

One exemplary nucleic acid amplification technique is PCR. Biochemical procedures for PCR amplification are generally described, for example, in: Dieffenbach and Dveksler (1995) PCR Primer: A Laboratory Manual, Cold Spring Harbor Laboratory Press; Sambrook & Russell (2001) Molecular Cloning: A Laboratory Manual, 3^{rd} Edition, Cold Spring Harbor Laboratory Press; U.S. Pat. Nos. 4,683,195 and 4,683,202, Saiki, et al. (1985) Science 230, 1350-1354.

A typical FP-PCR amplification reaction includes the following components: thermostable DNA polymerase, deoxynucleotides, a forward primer, a reverse primer, buffer and salts (e.g., 10 mM KCl, 10 mM (NH₄)₂S0₄, 20 M Tris-HCl, 2 mM MgSO₄, 0.1% Triton X-100, pH 8.8).

The forward and reverse primers are designed to specifically anneal to respective ends of a target sequence that is to be detected. For FP-PCR, one of the two primers of the pair is labeled with a fluorophore. Exemplary fluorophores for FP-PCR include: fluorescein (e.g., 6-carboxyfluorescein (6-FAM)), Texas Red, HEX, Cy3, Cy5, Cy5.5, Pacific Blue, 5-(and-6)-carboxytetramethylrhodamine (TAMRA), and Cy7.

In one implementation, a mixture is prepared with the amplification reaction components. Aliquots of the mixture are distributed into different wells in the microtitre plate sample carrier. Different samples are added to each of the wells. If desired, some of the wells can be used to prepare a dilution series for one or more of the samples. However, in some embodiments, accurate FP detection and appropriate algorithmic usage obviates the need for a dilution series to a quantitative measure of the initial target sequence concentration in various samples.

Temperature cycling: For FP-PCR, a standard PCR cycle can be used. For example, cycling between a denaturing temperature, an annealing temperature, and a primer extension temperature. Particular temperatures and times can depend on particular implementation details, e.g., on primer design, primer binding site sequence, and length of the amplified target sequence length.

As mentioned herein, in one embodiment, the heat-transfer block provides a thermal gradient. Thus, annealing temperatures, for example, can be varied among wells of a sample carrier.

Measurement of FP. FP is affected by temperature, among other factors. Hence, data is acquired from the sample carrier at a particular temperature during the thermal cycle. For example, one convenient temperature is between 40 and 70° C., 55-65, 37-42, or 65-75° C. The temperature can be a temperature at which unextended primers are annealed to binding sites on their complement (if present) or a temperature at which unextended primers are not annealed to their complements.

The PCR cycle can also be programmed to hold the sample carrier temperature at a temperature suitable for data acquisition once every cycle. In some implementations, a thermal probe is attached to the sample carrier. The probe can be inserted directly into the solution in one of the wells of the carrier. Temperature readings from the probe are used to trigger FP data acquisition. A record of the temperature can also be stored.

Linear PCR. In one embodiment, the PCR amplification is linear with respect to concentration of extended primers and time. Only a single primer is used for linear PCR. In other words, a reverse primer is not used. Amplification proceeds linearly with time since during each cycle the number of extended primers formed is equal to the number of target molecules present in the initial sample. The slope of the plot of extended primer concentration vs. time can be used to determine the number of initial molecules. Linear PCR, therefore, can be used to obtain very accurate measures of target molecule concentrations in the initial sample, provided the amount is sufficient for detection by linear amplification.

The methods and apparati can also be adapted to other nucleic acid amplification techniques. Some other examples include: transcription-based methods that utilize, for example, RNA synthesis by RNA polymerases to amplify nucleic acid (U.S. Pat. No. 6,066,457; U.S. Pat. No. 6,132,997; U.S. Pat. No. 5,716,785; Sarkar et al., Science (1989) 244: 331-34; Stofler et al., Science (1988) 239: 491; U.S. Pat. Nos. 5,130,238; 5,409,818; and 5,554,517 (for NASBA); strand displacement amplification (SDA; U.S. Pat. Nos. 5,455,166 and 5,624,825); ligase chain reaction (LCR). With respect to LCR, since the ligation of a labeled probe to a small unlabeled oligonucleotide may only result in a small difference in FP, the labeled probe can be ligated to a large, unlabeled molecule in order to increase the change in FP signal upon ligation; and a flap endonuclease-based cleavage, e.g., as described in U.S. Pat. Nos. 588,870 and 6,001,567.

With respect to some of these other amplification techniques, amplification can be isothermal. The detection system can sample the reaction mixture (or mixtures) at multiple intervals during the amplification. Typically, regular intervals are chosen.

Of course, aspects of the apparati described herein can be used to monitor polarized light for any sample and also for any chemical reaction,

Multiplex Primer Analysis

More than one target nucleic acid sequence can be analyzed at one or more discrete addresses of a reaction chamber (e.g., samples of a sample carrier, e.g., wells of a microtitre plate). A different labeled primer is used for each target sequence. For example, two primers that amplify related or unrelated sequences are labeled with different fluorophores.

To detect two alleles of a gene, the reaction can include

a first primer specific for the first allele and labeled with a first fluorophore;

a second primer specific for the second allele and labeled with a second fluorophore; and

a third primer that binds to both the first and second allele, on the apposing strand.

If the first allele is present, the first and third primer amplify the target sequence. If the second allele is present, the second and third primer amplify the target sequence. If the allele is an SNP, the inappropriate primer may hybridize and prime synthesis of the allele that is present. However, quantitative detection would, nevertheless, indicate preferential amplification by the appropriate primer. In addition, the primers' query position which distinguish the SNP may be judiciously positioned, e.g., at or near the 3′ terminus of the primer (e.g., within 1, 2, 3, 4 or 5 nucleotides of the terminus). The primer can also include deliberate mismatches, e.g., adjacent to or near the query position, to decrease the Tₘ of the primer and increase its sensitivity.

To detect two unrelated target nucleic acids, the reaction can include:

a first primer specific for the first nucleic acid and labeled with a first fluorophore;

a second primer specific for the first nucleic acid, and hybridizing to a site on the first nucleic acid such that a segment of the nucleic acid is amplified in combination with the first primer.

a third primer specific for the second nucleic acid and labeled with a second fluorophore; and

a fourth primer specific for the second nucleic acid and hybridizing to a site on the second nucleic acid, such that a segment of the nucleic acid is amplified in combination with the third primer.

The two unrelated nucleic acids might be genes transcribed by the same cell, e.g., genes encoding actin and p53. In another example, the two unrelated genes might be an antibiotic resistance gene and a gene indicative of bacterial virulence.

Multiple different fluorophores (e.g., at least two, three, four, five, or six different fluorophores )can be used in a multiplex analysis . An exemplary set of six includes: (1) 6-FAM; (2) HEX; (3) Texas Red; (4) Cy5; (5) Cy5.5; and (6) a fluorophore selected from the following group: Cy3, Pacific Blue, TAMRA, and Cy7. In general, any set of fluorophores for which the emission and/or excitation peaks are separable can be used. Moreover, both need not be separable, so long as they can be separated by detection or by excitation.

It is also possible to use an intercalating dye in an implementation that does not require the amplification primer to be fluorescently labeled (although it may be with a different dye that does not interfere). Exemplary intercalating dyes include Sybr Green which is an intercalating dye that binds to the minor grooves in double-stranded DNA, and ethidium bromide.

A number of embodiments of the invention have been described. Nevertheless, it will be understood that various modifications may be made without departing from the spirit, and scope of the invention. For example, in the described embodiments, the systems can discriminate between light of orthogonal plane-polarized states. It is also possible to modify the elements to distinguish circularly polarized light from unpolarized light, for example, by adding additional optics to enable discrimination of circularly polarized states. Accordingly, other embodiments are within the scope of the following claims.

1. An optical device for receiving light, the device comprising:
a polarizing beam splitter (PBS) that substantially reflects light of a first polarization and substantially transmits light of a second polarization orthogonal to the first polarization;
a reflector positioned to reflect light transmitted by the PBS towards the PBS; and
a detector positioned to detect light reflected by the PBS and/or light reflected by the reflector.

2. The optical device of claim 1 wherein the reflector is angled relative to the PBS.

3. The optical device of claim 1
wherein the reflector is angled relative to the PBS such that a light beam that has a non-zero angle of incidence at the PBS is separated into a first beam having substantially the first polarization and a second beam having substantially the second polarization; and
the detector is positioned to detect the first and second beam.

4. The optical device of claim 3, wherein upon reflection of the second beam by the reflector, the angle between the first and second beam is at least 1°.

5. The optical device of claim 1, wherein the device is configured to receive light having a wavelength between 380 nm and 780 nm.

6. The optical device of claim 5, wherein the device is configured to receive light having a wavelength between 400 nm and 680 nm.

7. The optical device of claim 1, wherein the PBS comprises substrate having a first and second surface, at least one of which being coated with a substantially parallel array of elongated conducting elements, and the coated surface substantially reflects light of the first polarization and substantially transmits light of the second polarization.

8. The optical device of claim 3, wherein the detector comprises a first and second region, the detector being positioned to receive the first beam in the first region and the second beam in the second region.

9. The optical device of claim 7 wherein the reflector comprises a coating on the second surface of the PBS substrate, and the PBS second surface and the PBS first surface are angled.

10. The optical device of claim 3 further comprising a polarizer positioned in the path of the first beam, but not the second beam, wherein the polarizer is oriented substantially transmit light of the first polarization.

11. The optical device of claim 6 further comprising an optical element that directs light from the sample to the PBS.

12. A method of detecting fluorescence polarization of a sample, the method comprising:
exciting the sample with excitation light;
directing emitted light from the sample at the optical device of claim 3; and
detecting light at the detector.

13. The method of claim 12 wherein the PBS comprises substrate having a first and second surface, at least one of which being coated with a substantially parallel array of elongated conducting elements, and the coated surface substantially reflects light of the first polarization and substantially transmits light of the second polarization.

14. The method of claim 12 wherein the excitation light is polarized in a single plane.

15. The method of claim 12 wherein the excitation light is circularly polarized.

16. The method of claim 12 wherein the detecting comprises detecting light in the first and second beam.

17. The method of claim 16 wherein the light in the first and second beam are detected concurrently.

18-22. (canceled)

23. A method of detecting fluorescence polarization of a sample, the method comprising:
exciting the sample with first polarized excitation light;
directing first emitted light from the sample at the optical device of claim 3;
detecting light in the first and second beam to evaluate orthogonal components of the first emitted light;
exciting the sample with second polarized excitation light, non-parallel to the first polarized excitation light;
directing second emitted light from the sample at the optical device;
detecting light in the first and second beam to evaluate orthogonal components of the second emitted light; and
determining a first value that is a function of the components of the first emitted light and a second value that is a function of the components of the second emitted light.

24. The method of claim 23, further comprising evaluating a function that depends on the first and second values.

25-27. (canceled)

28. A polarizing beam splitter (PBS) comprising:
an optically transparent substrate, having a front surface and a rear surface angled relative to the front surface;
a generally parallel array of elongated elements disposed on the front surface of the substrate configured to substantially reflect light of a first polarization, and substantially transmit light of a second polarization orthogonal to the first polarization; and
a reflective coating disposed on the rear surface.

29. The PBS of claim 28 wherein the elements are composed of aluminum or silver.

30. The PBS of claim 28, wherein the array is configured to polarize light having a wavelength between 380 nm and 780 nm.

31. The PBS of claim 30 wherein the array is configured to polarize light having a wavelength between 420 and 600 nm.

32. The PBS of claim 28 wherein the angle between the front and rear surfaces is between 5 and 50°.

33. The PBS of claim 28 wherein the reflective coating does not substantially alter the polarization of light that it reflects.

34. The PBS of claim 28 wherein the reflective coating is substantially uniform.

35. The PBS of claim 28 wherein the substrate is a wedge.

36. The PBS of claim 28, wherein the rear surface is angled relative to the front surface such that a light beam that has a non-zero angle of incidence at the front surface is separated into a first beam having substantially the first polarization and a second beam having substantially the second polarization, and upon reflection of the second beam by the reflector, the angle between the first and second beam is at least 1°.

37. A method of evaluating fluorescence polarization, the method comprising:
collecting light from a plurality of distinguishable positions on an illuminated object;
separating the collected light according to polarity using an optical element that reflects light polarized in a first plane and transmits light in a second plane, orthogonal to the first plane;
projecting the reflected light and the transmitted light onto a detector surface; and
comparing the reflected and the transmitted light for each of the distinguishable positions to thereby determine fluorescence polarization at each of the distinguishable positions.

38. The method of claim 37 wherein the light in the second plane is reflected off a reflector towards the optical element.

39. A method comprising:
providing a plurality of spatially distinct nucleic acid samples and amplification reagents that comprises a fluorophore attached to a nucleic acid primer;
concurrently amplifying each sample of the plurality; and
during the amplifying, concurrently detecting fluorescence polarization information associated with the fluorophore from each sample of the plurality, wherein the detecting comprises separating first and second polarity light using an element that reflects first polarity light and transmits second polarity light, wherein the first polarity light is polarized in a first plane and the second polarity light is polarized in a plane orthogonal to the first plane.

40. The method of claim 39 wherein the first and second polarity light are detected concurrently.

41. The method of claim 39 wherein the first and second polarity light are detected by the same detector.

42. The method of claim 39 wherein the element comprises an optically transparent substrate having a first and second surface and a parallel array of conductive material coated on the first surface.

43. An apparatus comprising:
the optical device of claim 3;
a light source;
a retainer configured to position a sample to receive light from the light source and to direct light emitted from the sample to the optical device.

44-49. (canceled)
